(19) United States
(12) Patent Application Publication
(10) Pub. No.: US 2005/0140905 A1
(43) Pub. Date: Jun. 30, 2005

(54) In-plane field type transflective liquid crystal display

(75) Inventor: Chiu-Lien Yang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/026,594

(22) Filed: Dec. 30, 2004

(30) Foreign Application Priority Data
Dec. 31, 2003 (JP) 92137542

(51) Int. Cl. G02F 1/1343

(52) U.S. Cl. 349/141

(57) ABSTRACT

A liquid crystal display device (10) includes an upper substrate (12), a lower substrate (14), and a liquid crystal layer (16) interposed between the upper substrate and the lower substrate. An upper polarizer (126) and a lower polarizer (146) are positioned at the upper and lower substrates respectively, with at least one of the polarizers being an extraordinary type polarizer. Each of pixel regions includes a pixel electrode (148a) and a common electrode (148b), for applying a voltage to the liquid crystal layer. Each pixel region defines a reflection region and a transmission region. All the pixel and common electrodes are positioned at the lower substrate. The display device works both in a reflection mode and a transmission mode, has a wide viewing angle, can work at high temperatures, and is relatively thin and compact.

### BACKGROUND OF THE INVENTION

1. Cross Reference to Related Applications

This application is related to co-pending applications entitled “In-plane field type transflective liquid crystal display device” and “Transflective liquid crystal display device,” both of which are assigned to the same assignee as this application.

2. Field of the Invention

The present invention relates to liquid crystal displays, and more particularly to an in-plane field type transflective liquid crystal display device having at least one extraordinary type polarizer.

3. Description of the Prior Art

Due to the features of being thin and consuming little power, liquid crystal display devices have been used in a broad range of fields. Applications include office automation (OA) apparatuses such as word processors and personal computers, portable information apparatuses such as portable electronic schedulers, videocassette recorders (VCRs) provided with information panels, and mobile phones provided with liquid crystal monitors.

Unlike with a cathode ray tube (CRT) display or an electroluminescence (EL) display, the liquid crystal display screen of a liquid crystal display device does not emit light itself. Instead, in a conventional transmission type liquid crystal display device, an illuminator called a backlight is provided at a rear or one side of the liquid crystal display device. The amount of light received from the backlight which passes through the liquid crystal panel is controlled by the liquid crystal panel, in order to provide images for display.

In the transmission type liquid crystal display device, the backlight consumes 50% or more of the total power consumed by the liquid crystal display device. That is, the backlight is a major contributor to power consumption.

In order to overcome the above problem, a reflection type liquid crystal display device has been developed for portable information apparatuses which are often used outdoors or in places where artificial ambient light is available. The reflection type liquid crystal display device is provided with a reflector formed on one of a pair of substrates, instead of having a backlight. Ambient light is reflected from a surface of the reflector to illuminate the display screen.

The reflection type liquid crystal display device using the reflection of ambient light is disadvantageous, insofar as the visibility of the display screen is extremely low when the surrounding environment is dark. Conversely, the transmission type liquid crystal display device is disadvantageous when the surrounding environment is bright. That is, the color reproduction is low and the display screen is not sufficiently clear because the display brightness is only slightly less than the brightness of the ambient light. In order to improve the display quality in a bright surrounding environment, the intensity of the light from the backlight needs to be increased. This increases the power consumption of the backlight and reduces the efficiency of the liquid crystal display device. Moreover, when the liquid crystal display device needs to be viewed at a position exposed to direct sunlight or direct artificial light, the display quality is generally lower. For example, when a display screen fixed in a car or a display screen of a personal computer receives direct sunlight or artificial light, surrounding images are reflected from the display screen, making it difficult to observe the images of the display screen itself.

In order to overcome the above problems, an apparatus which realizes both a transmission mode display and a reflection mode display in a single liquid crystal display device has been developed. The apparatus is called as a transflective liquid crystal display (TR-LCD), and has been disclosed in literature such as Japanese Laid-Open Publication No. 7-333598. The TR-LCD uses a semi-transmissive reflection film which partly transmits light and partly reflects light. Typically, the TR-LCD includes an upper substrate, a lower substrate, a liquid crystal layer interposed between the substrates, and the semi-transmissive reflection film. A common electrode is positioned on the upper substrate, and a plurality of pixel electrodes are positioned on the lower substrate. Two polarizers are positioned on outer surfaces of the upper substrate and the lower substrate, respectively. The polarizers are ordinary type polarizers, and are made of polyvinyl alcohol (PVA). The polarizers function to allow passage of ordinary polarized light beams, while blocking extraordinary polarized light beams. Polarizing axes of the polarizers are perpendicular to each other; that is, the polarizers are crossed polarizers.

However, the TR-LCD still has an inherent drawback that cannot be eliminated; namely, a very narrow viewing angle. By adding one or more compensation films on the TR-LCD, this problem can be ameliorated to some extent. However, the extra components increase costs proportionately.

In addition, because the polarizers are made of PVA, they cannot work at temperatures higher than 80 degrees Centigrade. This limits the kinds of application environments in which the TR-LCD can be used. Furthermore, because the polarizers are both positioned as outer surfaces of the TR-LCD, they are easily damaged or even destroyed in handling or in use. Moreover, in manufacturing of the TR-LCD, the polarizers are typically separate parts having protecting films. In the last step of manufacturing, the polarizers are adhered on the LCD panel. This makes the TR-LCD unduly thick and bulky.

It is desired to provide an in-plane field type transflective liquid crystal display which overcomes the above-described deficiencies.

### SUMMARY OF THE INVENTION

Accordingly, an object of the present invention is to provide a liquid crystal display device which has a wide view angle and which can work in both a reflection mode and a transmission mode.

Another object of the present invention is to provide a liquid crystal display device providing a bright, clear display under any ambient light conditions.

A further object of the present invention is to provide a transflective liquid crystal display which can work at high temperatures, and which is relatively thin and compact.

To achieve the above objects, a liquid crystal display device in accordance with the present invention comprises an upper substrate, a lower substrate and a liquid crystal layer interposed between the upper substrate and the lower substrate. An upper polarizer and a lower polarizer are positioned on the upper and lower substrate respectively, with one of the polarizers being an extraordinary type polarizer. Each of a plurality of pixel regions comprises a pixel electrode and a common electrode, for applying a voltage to the liquid crystal layer. Each pixel region defines a reflection region and a transmission region. All the pixel and common electrodes are positioned at either the upper substrate or the lower substrate.

In certain embodiments, the liquid crystal layer has different thicknesses in the reflection region and the transmission region of each pixel region. In further embodiments, the liquid crystal display device includes a color filter layer with different thicknesses in the reflection region and the transmission region of each pixel region. Alternatively, a part of the color filter layer in the reflection region of each pixel region has no color dye therein.

Other objects, advantages and novel features of the present invention will be apparent from the following detailed description of exemplary embodiments thereof with reference to the attached drawings, in which:

### BRIEF DESCRIPTION OF THE DRAWINGS

FIG. 1A is a schematic, cross-sectional view of one pixel region of an in-plane field type transflective liquid crystal display device (“the LCD”) according to a first exemplary embodiment of the present invention, showing the LCD with no voltage applied, and backlight entering the LCD;

FIG. 1B is similar to FIG. 1A, but showing the LCD with a voltage applied and resulting electric fields;

FIG. 1C is an enlarged view of a dielectric transflector of the LCD of FIGS. 1A and 1B, showing essential optical paths thereof;

FIG. 2A is a schematic, cross-sectional view of one pixel region of an in-plane field type transflective liquid crystal display device (“the LCD”) according to a second exemplary embodiment of the present invention, showing the LCD with no voltage applied, and backlight entering the LCD;

FIG. 2B is similar to FIG. 2A, but showing the LCD with a voltage applied and resulting electric fields;

FIG. 3 is a schematic, cross-sectional view of one pixel region of an in-plane field type transflective liquid crystal display device (“the LCD”) according to a third exemplary embodiment of the present invention, showing the LCD with a voltage applied and resulting electric fields, and backlight entering the LCD;

FIG. 4 is a schematic, cross-sectional view of one pixel region of an in-plane field type transflective liquid crystal display device (“the LCD”) according to a fourth exemplary embodiment of the present invention, showing the LCD with a voltage applied and resulting electric fields, and backlight entering the LCD;

FIG. 5A is a schematic, cross-sectional view of one pixel region of an in-plane field type transflective liquid crystal display device (“the LCD”) according to a fifth exemplary embodiment of the present invention, showing the LCD with a voltage applied and resulting electric fields, and backlight entering the LCD;

FIG. 5B is an enlarged view of a dielectric transflector of the LCD of FIG. 5A, showing essential optical paths thereof;

FIG. 6 is a schematic, cross-sectional view of one pixel region of an in-plane field type transflective liquid crystal display device (“the LCD”) according to a sixth exemplary embodiment of the present invention, showing the LCD with a voltage applied and resulting electric fields;

FIG. 7 is a schematic, cross-sectional view of one pixel region of an in-plane field type transflective liquid crystal display device (“the LCD”) according to a seventh exemplary embodiment of the present invention, showing the LCD with a voltage applied and resulting electric fields, and backlight entering the LCD;

FIG. 8 is a schematic, cross-sectional view of one pixel region of an in-plane field type transflective liquid crystal display device (“the LCD”) according to an eighth exemplary embodiment of the present invention, showing the LCD with a voltage applied and resulting electric fields;

FIG. 9 is a schematic, cross-sectional view of one pixel region of an in-plane field type transflective liquid crystal display device (“the LCD”) according to a ninth exemplary embodiment of the present invention, showing the LCD with a voltage applied and resulting electric fields, and backlight entering the LCD;

FIG. 10 is a schematic, cross-sectional view of one pixel region of an in-plane field type transflective liquid crystal display device (“the LCD”) according to a tenth exemplary embodiment of the present invention, showing the LCD with a voltage applied and resulting electric fields;

FIG. 11 is a schematic, cross-sectional view of one pixel region of an in-plane field type transflective liquid crystal display device (“the LCD”) according to an eleventh exemplary embodiment of the present invention, showing the LCD with a voltage applied and resulting electric fields, and backlight entering the LCD;

FIG. 12 is a schematic, cross-sectional view of one pixel region of an in-plane field type transflective liquid crystal display device (“the LCD”) according to a twelfth exemplary embodiment of the present invention, showing the LCD with a voltage applied and resulting electric fields;

FIG. 13 is a schematic, cross-sectional view of one pixel region of an in-plane field type transflective liquid crystal display device (“the LCD”) according to a thirteenth exemplary embodiment of the present invention, showing the LCD with a voltage applied and resulting electric fields, and backlight entering the LCD; and

FIG. 14 is a schematic, cross-sectional view of one pixel region of an in-plane field type transflective liquid crystal display device (“the LCD”) according to a fourteenth exemplary embodiment of the present invention, showing the LCD with a voltage applied and resulting electric fields.

### DETAILED DESCRIPTION OF THE EXEMPLARY EMBODIMENTS

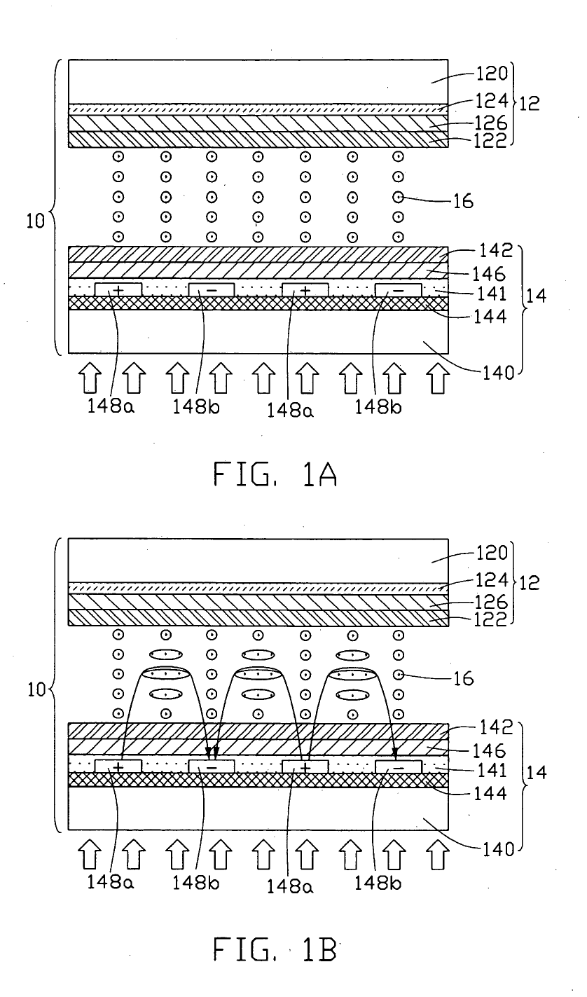

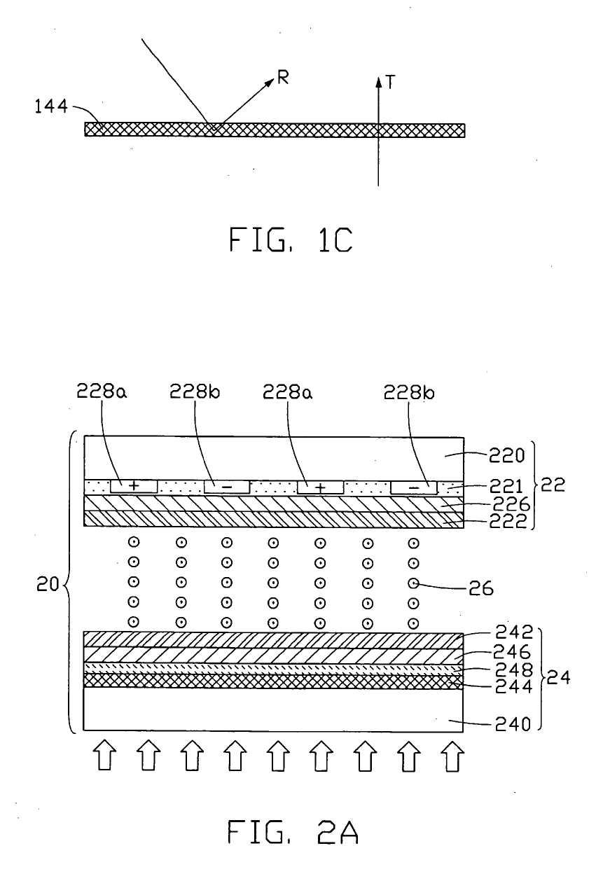

Referring to FIGS. 1A and 1B, a liquid crystal display device 10 of Example 1 according to the present invention includes an upper substrate 12, a lower substrate 14, and a liquid crystal layer 16 interposed between the upper substrate 12 and the lower substrate 14. The upper substrate 12 comprises a color filter layer 124, an upper polarizer 126 and an upper alignment film 122 positioned in that order from top to bottom on a bottom surface of an upper glass plate 120. The lower substrate 14 comprises a dielectric transflector 144, a plurality of pairs of a pixel electrode 148a and a common electrode 148b, an insulating layer 141, a lower polarizer 146 and a lower alignment film 142 positioned in that order from bottom to top on an inner surface of a lower glass plate 140. The lower substrate 14 may comprise a thin film transistor (TFT) array (not shown) connecting with the pixel electrodes 148a. In an alternative embodiment, the upper glass plate 120 and the lower glass plate 140 can be made of silicon dioxide (SiO₂) instead.

The pixel electrodes 148a and the common electrodes 148b are made of a transparent conductor. A material of the transparent conductor can, for example, be indium tin oxide (ITO) or indium zinc oxide (IZO). The upper and lower alignment films 122, 142 are alignment layers for orientating liquid crystal molecules in the liquid crystal layer 16. The color filter layer 124 comprises a black matrix (not shown), and a color resin layer having Red, Green and Blue segments. The black matrix is disposed between segments of the color resin layer, to prevent light beams from leaking.

The upper and lower polarizers 126, 146 both are extraordinary type polarizers composed of mixtures of narrow-band components. Each narrow-band component comprises a modified organic dye material which exists in a liquid-crystalline phase. Polarizing axes of the polarizers 126, 146 are perpendicular to each other; that is, the polarizers 126, 146 are crossed polarizers. The polarizers 126, 146 pass extraordinary polarized light beams, while blocking ordinary polarized light beams. A thickness of each of the polarizers 126, 146 is less than 100 microns. This ensures that the operating voltage of the liquid crystal display device 10 is not affected by the polarizers 126, 146 being formed at inner surfaces of the upper substrate 12 and the lower substrate 14 respectively. In an alternative embodiment, the upper polarizer 126 can be an ordinary type polarizer.

The dielectric transflector 144 is a multi-layer stacked arrangement of dielectric materials. That is, each of one more or more stacks comprises a number of thin film dielectric layers. Referring to FIG. 1C, an optical reflectivity R and a transmissivity T of the dielectric transflector 144 can be controlled by configuring the thicknesses, the number and/or the refractive indexes of the layers thereof accordingly. That is, the duly configured dielectric transflector 144 can transmit backlight and can reflect ambient light. Thus the liquid crystal display device 10 provides a transflective display that works in both a transmission mode and a reflection mode. Further, because the dielectric transflector 144 does not conduct electricity, using the dielectric transflector 144 does not influence the distribution of electric fields in the liquid crystal layer 16.

In operation, when no voltage is applied between the pixel and common electrodes 148a and 148b, long axes of the liquid crystal molecules in the liquid crystal layer 16 maintain a predetermined angle relative to the upper alignment film 122 and the lower alignment film 142, and the liquid crystal molecules are stationed parallel to the upper and lower substrates 12 and 14.

When a voltage is applied (in the driven state), an electric field (not labeled) is generated between the pixel and common electrodes 148a, 148b. Because the pixel electrodes 148a and the common electrodes 148b are on the same layer, the electric field is substantially parallel to the upper and lower substrates 12, 14. The substantially parallel electric field drives the liquid crystal molecules of the liquid crystal layer 16 to rotate so they have a new orientation that is still parallel to the upper and lower substrates 12 and 14. The change in orientation results in a change in light transmission, and the displayed image has the important advantage of a wide viewing angle.

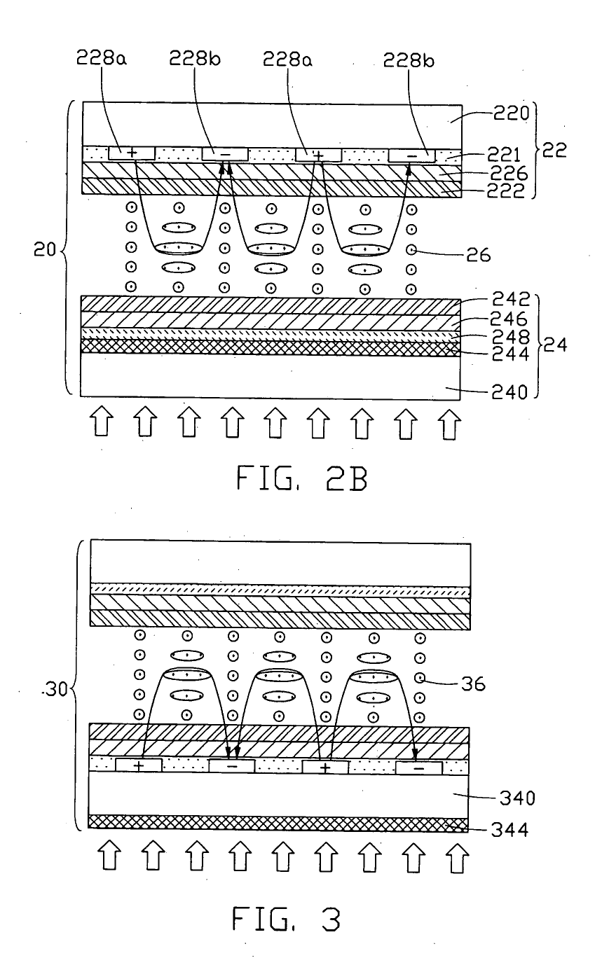

Referring to FIGS. 2A and 2B, a liquid crystal display device 20 of Example 2 according to the present invention includes an upper substrate 22, a lower substrate 24, and a liquid crystal layer 26 interposed between the upper substrate 22 and the lower substrate 24. The upper substrate 22 comprises a plurality of pairs of a pixel electrode 228a and a common electrode 228b, an insulating layer 221, an upper polarizer 226 and an upper alignment film 222 positioned in that order from top to bottom on a bottom surface of an upper glass plate 220. The lower substrate 24 comprises a dielectric transflector 244, a color filter layer 248, a lower polarizer 246 and a lower alignment film 242 positioned in that order from bottom to top on an inner surface of a lower glass plate 240. All the layers of the liquid crystal display device 20 of Example 2 have substantially the same structures as the corresponding layers of the liquid crystal display device 10 of Example 1.

Referring to FIG. 3, a liquid crystal display device 30 of Example 3 according to the present invention is structured similar to the liquid crystal display device 10 of Example 1. The difference is that a dielectric transflector 344 of Example 3 is positioned far away from a liquid crystal layer 36, on an outer surface of a lower glass plate 340.

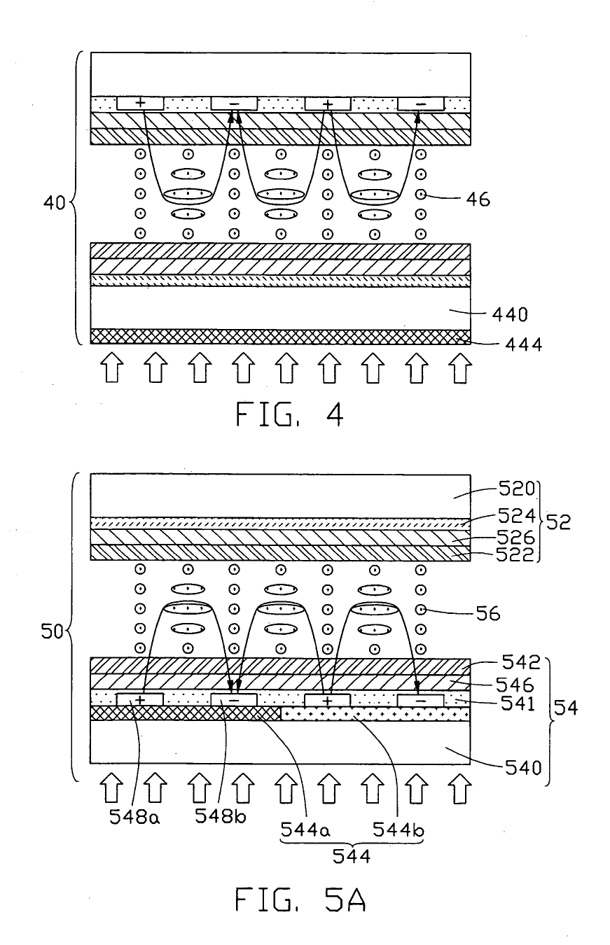

Referring to FIG. 4, a liquid crystal display device 40 of Example 4 according to the present invention is structured similar to the liquid crystal display device 20 of Example 2. The difference is that a dielectric transflector 444 of Example 4 is positioned far away from a liquid crystal layer 46, on an outer surface of a lower glass plate 440.

Referring to FIG. 5A, a liquid crystal display device 50 of Example 5 according to the present invention includes an upper substrate 52, a lower substrate 54, and a liquid crystal layer 56 interposed between the upper substrate 52 and the lower substrate 54. The upper substrate 52 comprises a color filter layer 524, an upper polarizer 526 and an upper alignment film 522 positioned in that order from top to bottom on a bottom surface of an upper glass plate 520. The lower substrate 54 comprises a dielectric transflector 544, a plurality of pairs of a pixel electrode 548a and a common electrode 548b, an insulating layer 541, a lower polarizer 546 and a lower alignment film 542 positioned in that order from bottom to top on an inner surface of a lower glass plate 540. The lower substrate 54 may comprise a thin film transistor (TFT) array (not shown) connecting with the pixel electrodes 548a. In an alternative embodiment, the upper glass plate 520 and the lower glass plate 540 can be made of silicon dioxide (SiO₂) instead.

All the layers except the dielectric transflector 544 of the liquid crystal display device 50 of Example 5 have substantially the same structures as the corresponding layers of the liquid crystal display device 10 of Example 1. Referring also to FIG. 5B, the dielectric transflector 544 includes a plurality of reflective areas 544a and a plurality of transmission areas 544b arranged alternately in a regular, repeating array. The reflective areas 544a and transmission areas 544b can each comprise a multi-layer stacked arrangement of dielectric materials, with each of one more or more stacks comprising a number of thin film dielectric layers. The optical reflectivity and transmissivity of the dielectric transflector 544 can be controlled by configuring the number of layers, the refractive indexes of the layers and/or the thicknesses of the layers in the stacks accordingly. Alternatively, the reflective areas 544a can be made of a highly reflective material such as aluminum, and the transmission areas 544b can be made of a translucent material or a material having one or more holes therein. A single reflective area 544a and an adjacent single transmission area 544b cooperatively define a single pixel region or part of a single pixel region. In the illustrated embodiment, for simplicity, it is assumed that a single reflective area 544a and an adjacent single transmission area 544b cooperatively define a single pixel region. Each pixel region thus comprises a transmission region and a reflection region. Accordingly, a plurality of pixel regions are defined by respective pairs of a reflective area 544a and a transmission area 544b. In manufacturing, a ratio of areas of the reflective area 544a and the transmission area 544b is configured so that the dielectric transflector 544 can transmit backlight and can reflect ambient light. Thus the liquid crystal display device 50 of Example 5 provides a transflective display that works in both a transmission mode and a reflection mode. Further, because the dielectric transflector 544 does not conduct electricity, using the dielectric transflector 544 does not influence the distribution of electric fields in the liquid crystal layer 56.

In operation, when no voltage is applied between the pixel and common electrodes 548a and 548b, long axes of liquid crystal molecules in the liquid crystal layer 56 maintain a predetermined angle relative to the upper alignment film 522 and the lower alignment film 542, and the liquid crystal molecules are stationed parallel to the upper and lower substrates 52 and 54.

When a voltage is applied (in the driven state), an electric field (not labeled) is generated between the pixel and common electrodes 548a, 548b. Because the pixel electrodes 548a and the common electrodes 548b are on the same layer, the electric field is substantially parallel to the upper and lower substrates 52, 54. The substantially parallel electric field drives the liquid crystal molecules of the liquid crystal layer 56 to rotate so they have a new orientation that is still parallel to the upper and lower substrates 52 and 54. The change in orientation results in a change in light transmission, and the displayed image has the important advantage of a wide viewing angle.

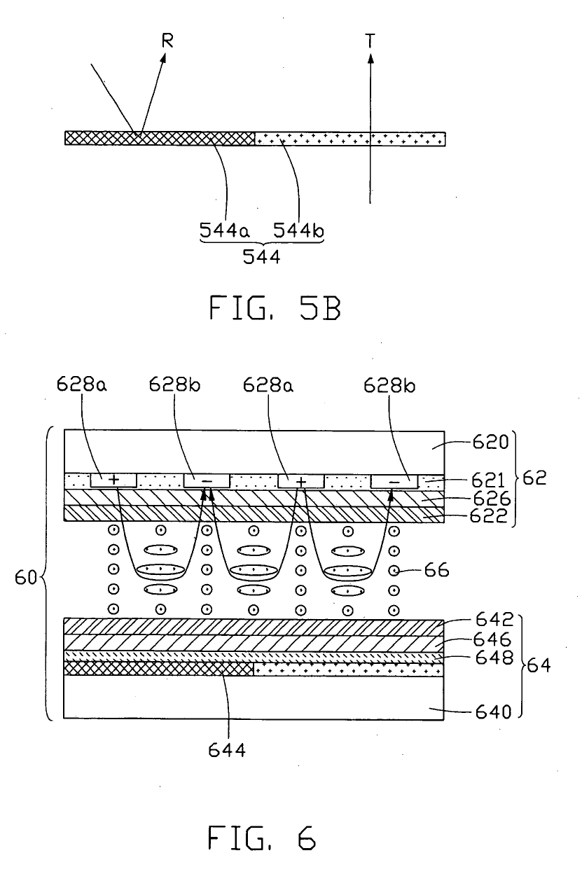

Referring to FIG. 6, a liquid crystal display device 60 of Example 6 according to the present invention includes an upper substrate 62, a lower substrate 64, and a liquid crystal layer 66 interposed between the upper substrate 62 and the lower substrate 64. The upper substrate 62 comprises a plurality of pairs of a pixel electrode 628a and a common electrode 628b, an insulating layer 621, an upper polarizer 626 and an upper alignment film 622 positioned in that order from top to bottom on a bottom surface of an upper glass plate 620. The lower substrate 24 comprises a dielectric transflector 644, a color filter layer 648, a lower polarizer 646 and a lower alignment film 642 positioned in that order from bottom to top on an inner surface of a lower glass plate 640. All the layers of the liquid crystal display device 60 of Example 6 have substantially the same structures as the corresponding layers of the liquid crystal display device 50 of Example 5.

In Examples 5 and 6, in each pixel region, a length of an optical path of light in the reflective area is substantially twice that in the transmission area. This can result in poor chromatic qualities, poor brightness, and a low contrast ratio of the displayed image. For balanced optical paths of light in the transmission region and the reflection region and a resultant improved displayed image, in Examples 7 through 14, a thickness of the liquid crystal layer dt in each transmission region is structured to be twice a thickness of the liquid crystal layer dr in each reflection region. That is, the liquid crystal layer is structured so that dt=2dr. With such structuring, the lengths of optical paths of light beams contributing to the displayed image (i.e., reflected light beams in the reflection region, and transmitted light beams in the transmission region) are substantially equal to each other. Although dt=2dr is preferable, dt and dr may be appropriately varied according to particular display characteristics, as long as dt>dr. Typically, dt is about 4 to 6 millimeters, and dr is about 2 to 3 millimeters. Accordingly, a kind of transmissive spacer having a thickness of about 2 to 3 millimeters is provided in each pixel region at either the upper substrate or the lower substrate.

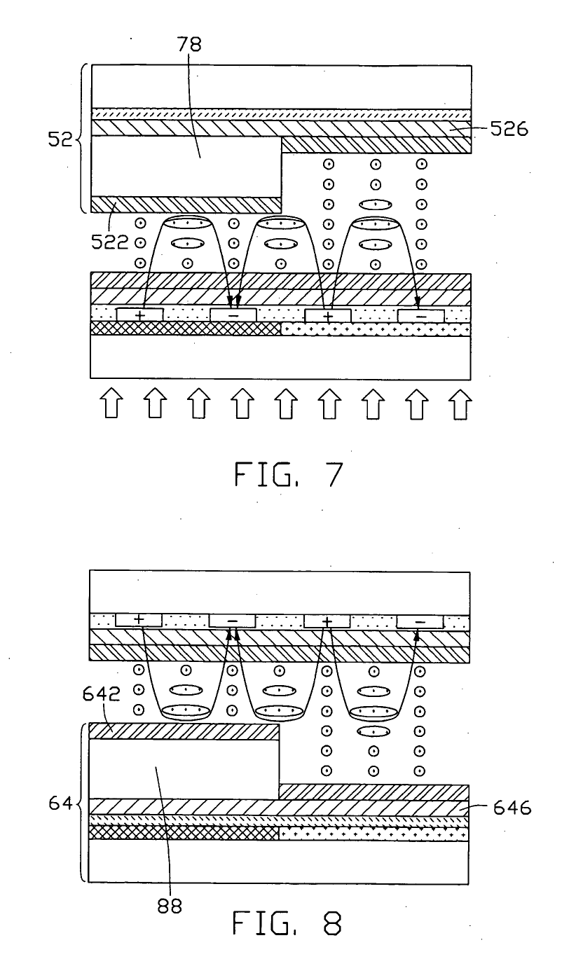

Referring to FIG. 7, in Example 7, a passivation layer 78 is added to each pixel region of the upper substrate 52 of the liquid crystal display device of Example 5. The passivation layer 78 is located in the reflection region between the upper polarizer 526 and the upper alignment film 522. Referring to FIG. 8, in Example 8, a passivation layer 88 is added to each pixel region of the lower substrate 64 of the liquid crystal display device of Example 6. The passivation layer 88 is located in the reflection region between the lower polarizer 646 and the lower alignment film 642.

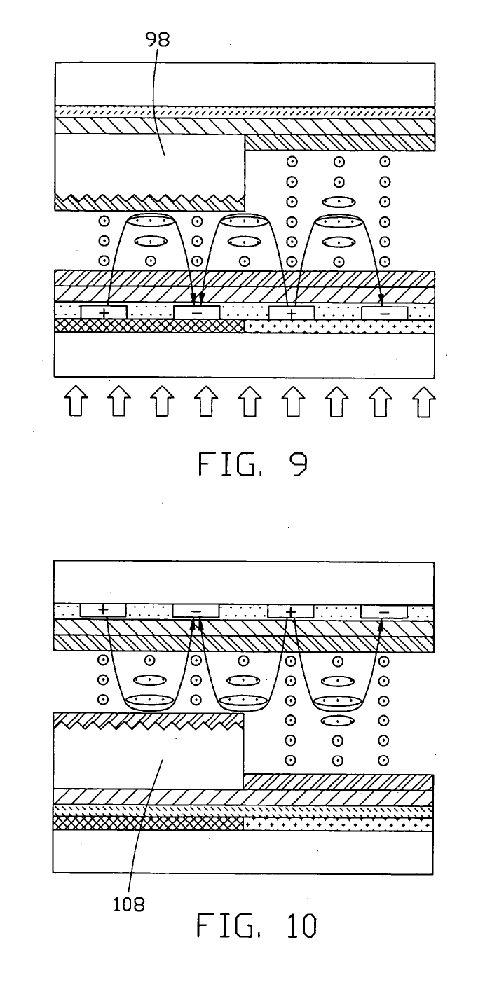

Referring to FIGS. 9 and 10, Examples 9 and 10 respectively shown therein are variations of Examples 7 and 8 respectively. In Examples 9 and 10, surfaces of passivation layers 98 and 108 are made uneven by etching or a like process. Typically, the surfaces define peaks and troughs. An average thickness of each of the passivation layers 98 and 108 is dr. The uneven surfaces of the passivation layers 98 and 108 are advantageous compared to the flat surfaces of the passivation layers 78 and 88 of Examples 7 and 8. This is because the uneven surfaces receive direct and reflected ambient light at various incident angles, and thus diffuse the direct and reflected ambient light. This gives the displayed image of the liquid crystal display device more uniform and higher brightness.

In Examples 5 through 10, in each pixel region, a length of an optical light path in the color filter in the reflection region is twice a length of an optical light path in the color filter in the transmission region. This can result in uneven and poor color purity in the displayed image. For balanced color purity in the transmission region and the reflection region and a resultant improved displayed image, Examples 11 through 14 provide variations of Examples 5 and 6.

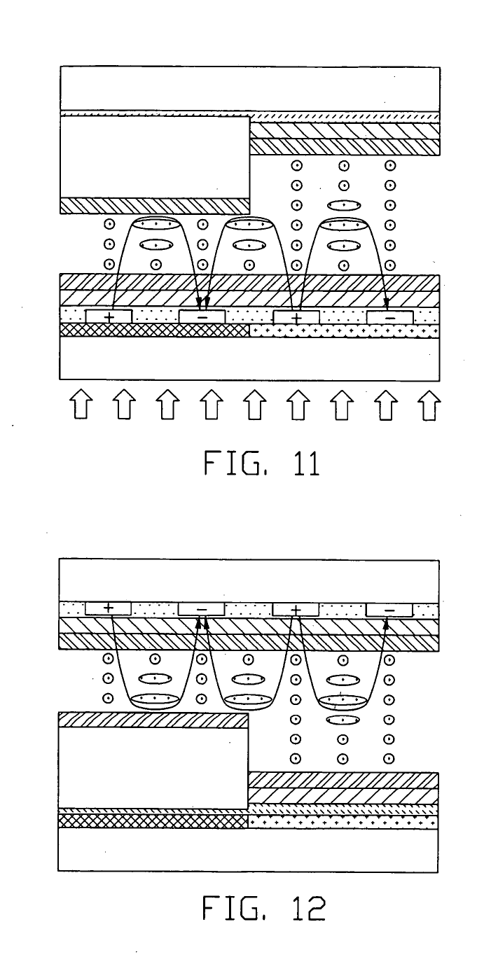

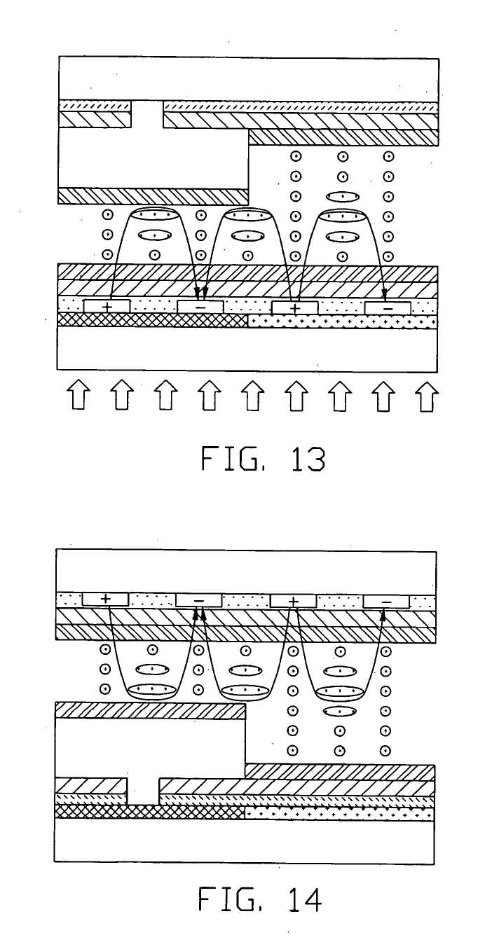

Referring to FIGS. 11 and 12, in each of Examples 11 and 12 respectively shown therein, a thickness of the color filter ft in the transmission region of each pixel region is structured to be twice a thickness of the color filter fr in the reflection region of the pixel region. That is, the liquid crystal layer is structured so that ft=2fr. With such structuring, the lengths of optical paths of light beams contributing to the displayed image (i.e., reflected colored light beams in the reflection region, and transmitted colored light beams in the transmission region) are substantially equal to each other. Referring to FIGS. 13 and 14, in each of Examples 13 and 14 respectively shown therein, the color filter in the reflection region of each pixel region is structured to have at least one part with no color dye therein. For example, the reflection region has at least one hole therein. With such structuring, reflected colored light beams in the reflection region and transmitted colored light beams in the transmission region have substantially equal color purity.

All the liquid crystal display devices of Examples 1 through 14 having the above-described structures effectively utilize incoming light. In particular, the light emitted from a backlight and passing through the transmission regions when ambient light is low, and the ambient light reflected at the reflection regions when the ambient light is high. In other words, both the transmission regions and the reflection regions can be utilized to generate a display image. Moreover, each liquid crystal display device provides an even, bright display and a wide viewing angle.

In addition, all the liquid crystal display devices of Examples 1 through 14 haves polarizers positioned within the liquid crystal cell thereof. At least one of the polarizers is an extraordinary type polarizer, and each of the polarizers has a thickness of less than 100 microns. Thus each liquid crystal display device resists damage that might occur because of contamination or foreign matter, and is thin and compact. Further, the liquid crystal display device is ideal for use in a touch LCD panel, because only a touch layer needs to be positioned thereon. Moreover, the polarizers in the liquid crystal display devices of Examples 1 through 14 are made of a modified organic dye material which exists in a liquid-crystalline phase. Therefore the liquid crystal display devices can work at temperatures up to 200 degrees Centigrade, and have a broader range of applications in the LCD marketplace.

It is to be understood, however, that even though numerous characteristics and advantages of the present invention have been set out in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A liquid crystal display device comprising:
an upper substrate;
a lower substrate;
a liquid crystal layer interposed between the upper substrate and the lower substrate;
an upper polarizer and a lower polarizer positioned at the upper and lower substrates respectively, with at least one of the polarizers being an extraordinary type polarizer;
a plurality of pixel regions, each pixel region comprising a pixel electrode and a common electrode, for applying a voltage to the liquid crystal layer;
wherein each pixel region includes a reflection region and a transmission region; and
all the pixel and common electrodes are positioned at either the upper substrate or the lower substrate.

2. The liquid crystal display device as claimed in claim 1, wherein the lower substrate comprises a dielectric transflector, which comprises one or more stacks of dielectric materials, each stack comprising a plurality of thin film dielectric layers.

3. The liquid crystal display device as claimed in claim 1, wherein the lower substrate comprises a dielectric transflector, the dielectric transflector in each pixel region having a reflection area corresponding to the reflection region and a transmission area corresponding to the transmission region.

4. The liquid crystal display device as claimed in claim 3, wherein the upper substrate comprises in turn a glass plate, a color filter, the upper polarizer and an alignment film, and the lower substrate comprises in turn a glass plate, the dielectric transflector, the common and pixel electrodes, the lower polarizer and an alignment film.

5. The liquid crystal display device as claimed in claim 4, wherein the upper substrate further comprises passivation layers positioned in the reflection regions between the upper polarizer and the alignment film.

6. The liquid crystal display device as claimed in claim 5, wherein each of the passivation layers has an uneven surface nearest to the liquid crystal layer.

7. The liquid crystal display device as claimed in claim 6, wherein a thickness of the color filter in the reflection region of each pixel region is less than a thickness of the color filter in the transmission region of the pixel region.

8. The liquid crystal display device as claimed in claim 6, wherein a part of the color filter in the reflection region of each pixel region has at least one hole therein.

9. The liquid crystal display device as claimed in claim 3, wherein the reflection area of the dielectric transflector is made of one or more highly reflective materials, and the transmission area of the dielectric transflector is made of one or more translucent materials or a material having one or more holes therein.

10. The liquid crystal display device as claimed in claim 1, wherein the lower substrate comprises in turn the dielectric transflector, a glass plate, the common and pixel electrodes, the lower polarizer and an alignment film.

11. The liquid crystal display device as claimed in claim 1, wherein the upper substrate comprises in turn a glass plate, the common and pixel electrodes, the upper polarizer and an alignment film, and the lower substrate comprises in turn a glass plate, the dielectric transflector, a color filter, the lower polarizer and an alignment film.

12. The liquid crystal display device as claimed in claim 1, wherein the lower and the upper polarizer both are extraordinary type polarizers.

13. The transflective liquid crystal display as claimed in claim 12, wherein the polarizers are made of a modified organic dye material which exists in a liquid crystalline phase.

14. A liquid crystal display device comprising:
an upper substrate;
a lower substrate;
a liquid crystal layer interposed between the upper substrate and the lower substrate;
an upper polarizer and a lower polarizer positioned at the upper and lower substrates respectively, with at least one of the polarizers being an extraordinary type polarizer;
a plurality of pixel regions, each pixel region comprising a pixel electrode and a common electrode for applying a voltage to the liquid crystal layer, and each pixel region defining a reflection region and a transmission region; and
a color filter positioned at either the upper substrate or the lower substrate, and having different thicknesses in the reflection region and the transmission region of each pixel region;
wherein all the pixel and common electrodes are positioned at either the upper substrate or the lower substrate.

15. The liquid crystal display device as claimed in claim 14, wherein the lower substrate comprises a dielectric transflector, which comprises one or more stacks of dielectric materials, each stack comprising a plurality of thin film dielectric layers.

16. The liquid crystal display device as claimed in claim 14, wherein a thickness of the color filter in the transmission region of each pixel region is substantially twice a thickness of the color filter in the reflection region of the pixel region.

17. A liquid crystal display device comprising:
an upper substrate;
a lower substrate;
a liquid crystal layer interposed between the upper substrate and the lower substrate;
two polarizers positioned at the upper and lower substrates respectively, and being made of a modified organic dye material which exists in a liquid crystalline phase;
a plurality of pixel regions, each pixel region comprising a pixel electrode and a common electrode for applying a voltage to the liquid crystal layer, and each pixel region defining a reflection region and a transmission region; and
a color filter positioned at either the upper substrate or the lower substrate, the color filter in each pixel region having a part in the reflection region with no color dye therein;
wherein all the pixel and common electrodes are positioned at either the upper substrate or the lower substrate.

18. The liquid crystal display device as claimed in claim 17, wherein the lower substrate comprises a dielectric transflector, which comprises one or more stacks of dielectric materials, each stack comprising a plurality of thin film dielectric layers.

19. The liquid crystal display device as claimed in claim 17, wherein the lower substrate comprises a dielectric transflector, the dielectric transflector in each pixel region having a reflection area corresponding to the reflection region and a transmission area corresponding to the transmission region.

20. The liquid crystal display device as claimed in claim 17, wherein a thickness of the color filter in the transmission region of each pixel region is substantially twice a thickness of the color filter in the reflection region of the pixel region.

21. The liquid crystal display device as claimed in claim 17, wherein a part of the color filter in the reflection region of each pixel region has at least one hole therein.
